(19) United States
(12) Patent Application Publication
(10) Pub. No.: US 2007/0063497 A1
(43) Pub. Date: Mar. 22, 2007

(54) Generator for restraining device

(75) Inventor: Masayuki Nakayasu, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/524,484

(22) Filed: Sep. 21, 2006

Related U.S. Application Data
(60) Provisional application No. 60/721,075, filed on Sep. 28, 2005.
(60) Provisional application No. 60/723,443, filed on Oct. 5, 2005.

(30) Foreign Application Priority Data
Sep. 22, 2005 (JP) 2005-275505
Oct. 3, 2005 (JP) 2005-289546

(51) Int. Cl. B60R 21/26

(52) U.S. Cl. 280/736

(57) ABSTRACT

A gas generator for a restraining device in an automobile, including a cylindrical housing having two opening portion, an ignition device chamber connected to one of the opening portions of the cylindrical housing, a diffuser portion connected to the other opening portion of the cylindrical housing and having a gas discharge port, a first blockage member closing between the cylindrical housing and the ignition device chamber, a second blockage member closing between the cylindrical housing and the diffuser portion, a pressurized gas charged inside the cylindrical housing, a metal rod, for rupturing the second blockage member to open a path to the diffuser portion in actuation, being provided in the cylindrical housing, the metal rod being disposed, having a base portion thereof in contact with a metallic wall surface in the vicinity of the first blockage member, an elastic material being inserted into the contacting portion which is pressed from both of the base portion and the metallic wall surface in the vicinity of the first blockage member.

This nonprovisional application claims priority under 35 U.S.C.§ 119(a) on Patent Applications No. 2005-275505 filed in Japan on 22 Sep. 2005 and No. 2005-289546 filed in Japan on 3 Oct. 2005, and 35 U.S.C.§ 119(e) on U.S. Provisional Applications No. 60/721,075 filed on 28 Sep. 2005 and No. 60/723,443 filed on 5 Oct. 2005, which are incorporated by reference.

### BACKGROUND OF THE INVENTION

1. Field of Invention

The present invention relates to a gas generator for use in an occupant restraining device for a vehicle, such as an air bag, an inflatable belt, and a pedestrian protection device

2. Description of Related Art

In a gas generator that inflates a restraining device such as an air bag in a vehicle occupant restraining device or a pedestrian protection device, an air bag is connected to a gas discharge port, and therefore, it is preferable that an igniter, which is connected to a lead wire for ignition and becomes an obstacle for bag connection, does not exist in the vicinity of the gas discharge port.

U.S. Pat. No. 3,856,180 discloses an inflator using a pressurized gas in which an igniter and a gas discharge port are separated. In a gas generator using a pressurized gas, a rupturable plate is employed as a blockage member for blocking the gas discharge port, but during the actuation, the rupturable plate has to be ruptured to open the gas discharge path. In U.S. Pat. No. 3,856,180, a rupturable plate is ruptured by a rod actuated by a high-temperature high-pressure gas generated by the actuation of ignition device.

In the invention of U.S. Pat. No. 3,856,180, a squib 44 is attached to one end of an inflator container 12 accommodating the pressurized gas. The squib 44 is also attached to one end portion of a combustion chamber 16 formed in one end portion of the housing 12 and the squib is inserted into the housing 12 and disposed therein. A gas generating agent 34, that is ignited by the actuation of squib 44 and generates the high-temperature and high-pressure gas, is disposed in the combustion chamber 16, and a seal 80 serving as a rupturable plate is ruptured by pushing the rod 74 to the right. The rod is attached to a cap seal 60, and the cap seal 60 is joined to a wall 18 of a combustion chamber 16 and fixed by welding 68. The rupture between the wall portion 62 of the cap seal 60 and a skirt 64 is caused by the gas generated by the combustion of a charge 34 inside the combustion chamber 16.

### SUMMARY OF THE INVENTION

The present invention relates to a gas generator for use in an occupant restraining device for a vehicle, such as an air bag, an inflatable belt, and a pedestrian protection device.

The present invention provides a gas generator for a restraining device in an automobile, including:

a cylindrical housing having two opening portion, an ignition device chamber connected to one of the opening portions of the cylindrical housing, a diffuser portion connected to the other opening portion of the cylindrical housing and having a gas discharge port,

a first blockage member closing between the cylindrical housing and the ignition device chamber, a second blockage member closing between the cylindrical housing and the diffuser portion, a pressurized gas charged inside the cylindrical housing,

a metal rod, for rupturing the second blockage member to open a path to the diffuser portion in actuation, being provided in the cylindrical housing, the metal rod being disposed, having a base portion thereof in contact with a metallic wall surface in the vicinity of the first blockage member,

an elastic material being inserted into the contacting portion which is pressed from both of the base portion and the metallic wall surface in the vicinity of the first blockage member.

The present invention provides a gas generator for a restraining device for a vehicle, including:

a cylindrical housing having two opening portions, an ignition device chamber connected to one of the opening portion of the cylindrical housing, a diffuser portion connected to the other opening portion of the cylindrical housing and having a gas discharge port,

a first blockage member closing between the cylindrical housing and the ignition device chamber, a second blockage member closing between the cylindrical housing and the diffuser portion, and a pressurized gas charged in a first gas charged space inside the cylindrical housing,

a metal rod, for rupturing the second the blockage member and opening a path to the diffuser portion in actuation, being disposed inside the cylindrical housing, the metal rod being disposed, having a base portion thereof in contact of a metallic wall surface in the vicinity of the first blockage member,

a second gas charged space existing between the first blockage member and the base portion of the rod, a communication hole being provided in the base portion of the rod and communicating the first gas charged space with the second gas charged space.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows a longitudinal cross-sectional view of a gas generator;

FIG. 2 shows a partial enlarged view of the gas generator shown in FIG. 1;

FIG. 3 shows a partial enlarged view illustrating an embodiment different from that shown in FIG. 1;

FIG. 4 shows a partial enlarged view illustrating an embodiment different from that shown in FIG. 1;

FIG. 5 shows a partial enlarged view different from that shown in FIG. 1;

FIG. 6 shows a partial enlarged view illustrating an embodiment different from that shown in FIG. 1; and

FIG. 7 shows a perspective view of the rod of another embodiment.

### DETAILED DESCRIPTION OF INVENTION

In the structure of UP Patent No. 3,856,180, because the cap seal 60 side of the rod 74 is reliably fixed by welding 68, the cap seal is not shaken and does not generate noise under the effect of external vibrations. However, because it is fixed by welding 68, the welded zone 68 can be ruptured (when welding is weak) during actuation unless the welding conditions are strictly controlled, or the joint zone of the wall portion 62 and skirt 64 can be cleaved, or a spread in performance can occur due to the difference among the products, whereby the actuation reproducibility can be decreased.

Furthermore, the pressurized gas accommodation chamber and combustion chamber 16 are partitioned by the cap seal 60 and the pressure corresponding to the gas charging pressure is applied to the cap seal 60. Therefore, a pressure in excess of this pressure has to be generated in the combustion chamber 16 to move the rod 74.

The present invention provides a gas generator that has a structure in which an igniter and a gas discharge port are provided in separate positions and the blockage member in a gas discharge path to the gas discharge port is broken by a rod, wherein the rod is fixed in a simple matter, the occurrence of noise caused by rod unsteadiness is prevented, and high reliability guaranteeing pressure resistance of the container is ensured.

When the gas generator in accordance with the present invention is actuated, the first blockage member is broken by the pressure or shock wave created by the ignition device, the rod that received the pressure or shock wave is propelled forward and collides with the second blockage member, whereby the second blockage member is broken and a gas discharge passage leading to the gas discharge port is opened. As a result, the air bag is inflated. Prom the standpoint of ensuring the safety of vehicle occupants, the above-described operation has to be reliably performed over a period of 10 years or more, which is a service life of a vehicle. If the rod is shaken and generates noise under the effect of vibrations provided from the outside when the automobile runs, the occupant will feel uncomfortable and uneasy even if the reliability of actuation is not affected.

Accordingly, when an elastic body is inserted into the contact portion of the base portion of the rod and the metallic wall surface in the vicinity of the first blockage member, the elastic material will be pressed from both the base portion of the rod and the metallic wall surface, whereby the elastic material will be deformed to close tightly the gap between the base portion of the rod and the metallic wall surface (sometimes part of the elastic material can be scraped off). Furthermore, an elastic material, in which a force is generated that acts to restore the original shape (shape prior to the deformation), can be also used.

As a result, the unsteadiness of rod and noise generation caused by external vibrations can be prevented. Furthermore, by inserting an elastic material in the above-described manner, the base portion of the rod can separate itself from the metallic wall surface in the vicinity of the first blockage member easier than in the case where the two metal components are mated, and the rod can be propelled more smoothly.

The elastic material may be inserted by forming on the surface of the base portion of the rod, forming on the metallic wall surface, forming on both the surface of the base portion of the rod and the metallic wall surface, or sandwiching between the base portion of the rod and metallic surface.

The elastic material preferably has volume elasticity and can be made from a rubber (natural rubber, synthetic rubber), a resin (natural resin, synthetic resin), or an elastomer. No specific limitation is placed on the shape of the elastic material, but from the standpoint of facilitating the demonstration of volume elasticity, the thickness thereof is preferably 2 mm or more. The elastic material in accordance with the present invention also includes materials that do not demonstrate elasticity physically, but are capable of preventing the generation of noise by being pressed at the contacting portion from the base portion of the rod or metallic wall surface.

The rod has a rod-like shape of uniform diameter or locally different diameter. The base portion of the rod may have the same shape as other portions or may differ in shape therefrom. For example, a flange portion may be provided at the end part thereof.

In the gas generator in accordance with the present invention, a retainer for holding the distal end portion of the rod in the vicinity of the second blockage member can be disposed to hold the distal end portion of the rod, which is on the opposite end from the base portion of the rod, and prevent, e.g., the displacement of the rod prior to actuation.

The present invention further provides the gas generator, wherein an outer shell of the ignition device chamber is formed by an ignition device chamber housing, the ignition device chamber housing has a cylindrical wall formed to protrude inside the cylindrical housing, and the cylindrical wall and the base portion of the rod are in contact with each other.

The cylindrical wall is opened toward the second blockage member. Using such cylindrical wall in the ignition device-chamber housing facilitates the operation of fixing the base portion of the rod.

The present invention further provides the gas generator, wherein the cylindrical wall is inclined as to expand toward the second blockage member.

When such cylindrical wall is used, the opening portion is enlarged. As a result, the operation of fitting the base portion of the rod is facilitated and the propulsion of rod during actuation is also facilitated.

The present invention further provides the gas generator, wherein at least one of an inner surface of the cylindrical wall and an outer surface of the base portion of the rod has an elastic material.

The elastic material may be provided on at least one of the inner surface of the cylindrical wall and the outer surface of the base portion of the rod, or on both of them.

The present invention further provides the gas generator, wherein a protrusion is provided in a surface of the elastic material of the base portion of the rod.

It is preferred that the operation effect of the elastic materials be improved by deforming the protrusion provided in the elastic material to crush it.

The present invention further provides the gas generator, wherein the cylindrical housing and the base portion of the rod are in contact with each other, and at least one of an inner surface of the cylindrical housing and an outer surface of the base portion of the rod has an elastic material.

The elastic material may be provided on at least one of the inner surface of the cylindrical housing and the outer surface of the base portion of the rod, or on both of them.

The present invention further provides the gas generator, wherein the base portion of the rod is formed from an elastic material.

In this gas generator in accordance with the present invention, because the base portion of the rod has a communication hole and the first gas charged space and the second gas charged space communicate with each other via the communication hole, the two spaces are filled with the pressurized gas under the same pressure and the entire rod is subjected to the same charging pressure. Therefore, the rod movement during actuation is facilitated.

Furthermore, in a gas generator using a pressurized gas, pressure resistance of all the components of the gas generator has to be evaluated to seal the pressurized gas reliably. In the gas generator in accordance with the present invention, the first gas charged space and the second gas charged space are charged with the pressurized gas. Therefore, when the cylindrical housing, first blockage member, and second blockage member are evaluated as to whether they have sufficient resistance to the charging gas pressure, the evaluation of pressure resistance of the entire gas generator can be performed in a single step because all the components are subjected to the same pressure.

In the gas generator for a restraining device for a vehicle in accordance with the present invention, the base portion of the rod can be a member in the form of a substantially flat plate, and the communication hole can be a through hole formed in the member in the form of a substantially flat plate, or the base portion of the rod can be a member in the form of a substantially flat plate, and the communication hole can be a gap formed between the member in the form of a substantially flat plate and the metallic wall surface.

The communication hole serves to move the charged gas from the first gas charged space to the second gas charged space during gas charging. Therefore, the communication hole may have a diameter sufficient to move the high-pressure charged gas. When the first blockage member is broken by the shock wave or pressure wave generated within a short period of time by the actuation of the ignition device, the shock wave or pressure wave does not essentially, practically, pass through the communication hole, but acts to apply pressure to the base portion of the rod.

In the gas generator for a restraining device for a vehicle in accordance with the present invention, in a contact portion of the base portion and the metallic wall surface, an elastic material can be inserted to be pressed from both the base portion and the metallic wall surface.

By inserting the elastic material in such a manner, metallic noise generated when the base portion comes into contact with the metallic wall surface under the effect of external vibrations or the like can be prevented.

In the gas generator in accordance with the present invention, in the contact portion of the base portion of the rod, which is made from a metal, and the metallic wall surface in the vicinity of the first blockage member, an elastic material is inserted to be pressed from both the base portion and the metallic wall surface in the vicinity of the first blockage member. Therefore, the metal parts are prevented from colliding with each other under the effect of vibrations applied when the vehicle runs, and the generation of noise can be prevented.

Employing a structure in which the first gas charged space and second gas charged space are provided and the two spaces are charged with the pressurized gas facilitates the evaluation of pressure resistance of the entire gas generator.

### EMBODIMENT OF INVENTION

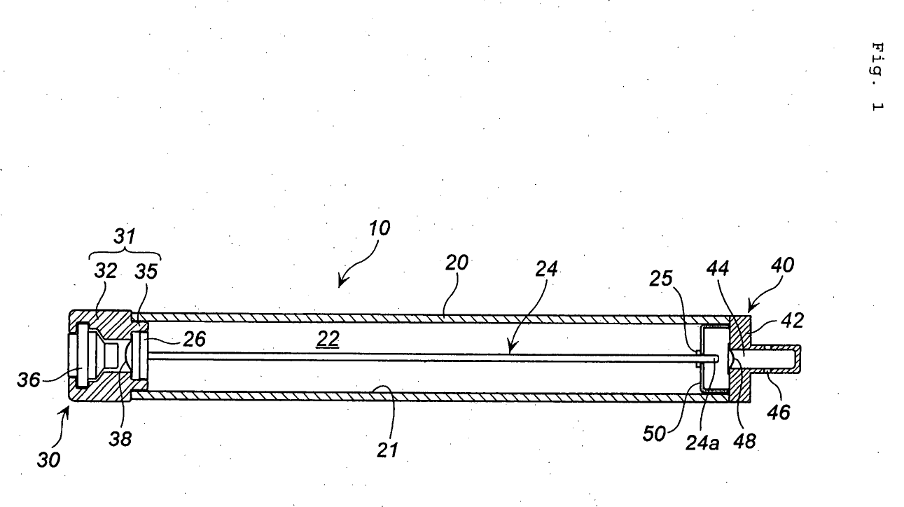

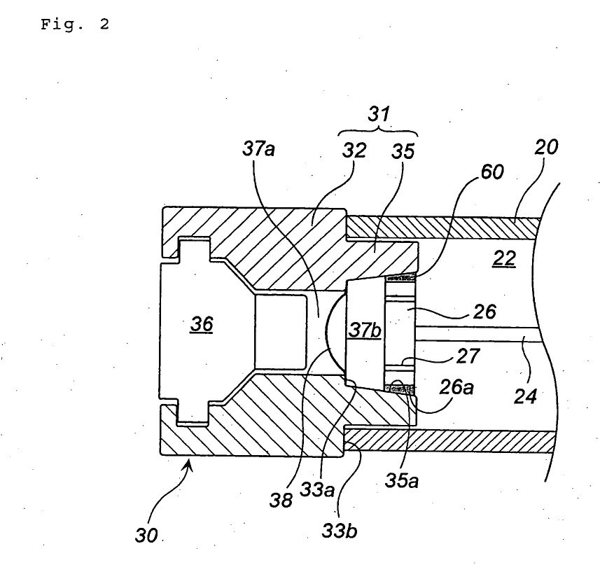

(1) Gas Generators Shown in FIGS. 1, 2

FIG. 1 is a cross-sectional view of a gas generator 10 for an air bag. FIG. 2 is a partial enlarged view of the gas generator shown in FIG. 1, but the shape of a part (cylindrical wall 35) is different. The gas generators shown in FIGS. 1, 2 are of a stored gas type using a pressurized gas as an air bag inflation means.

A cylindrical housing 20 has two opening portions on both end sides thereof, an ignition device chamber 30 connected to the opening portion at one end, and a diffuser portion 40 connected to the opening portion at the other end. Those components are made from stainless steel or aluminum, and fixed by welding in the respective joints thereof.

The inside of the inner space (first gas charged space) 22 of the cylindrical housing 20 is maintained in an air-tight state and filled with a single gas such as argon, helium, nitrogen, or a gas mixture thereof (the filling pressure is about 35,000-70,000 kPa). The pressurized gas preferably has a sound velocity of 400 m/sec or more at a temperature of 0° C. and under a pressure of 1 atm (101.325 kPa). The first gas charged space is charged with the pressurized gas through a charging port before it is blocked with a pin (not shown in the drawing), and then sealing is conducted by welding the pin and the cylindrical housing 20 together.

The ignition device chamber 30 has an outer shell formed by an ignition device chamber housing 31 and also has a cylindrical wall 35 on the side of the opening portion at one end of the main body 32, this cylindrical wall being formed so as to protrude into the cylindrical housing 20 (inner space or first gas charged space 22) so as to form an inner step portion 33a and an outer step portion 33b. The inner peripheral surface of the cylindrical wall 35 is inclined so that the wall expands in the direction of the opening portion (direction of the second blockage member 48), but as shown in FIG. 1, a configuration without the inclination is also possible.

An electric igniter 36 provided with an ignition agent is accommodated in the opening portion at other end of the main body 32. The igniter 36 is connected to a power supply circuit of the vehicle via a connector and a lead wire (none is shown in the drawing). The igniter 36 includes 260 mg of an ignition agent having zirconium and potassium perchlorate as the main components A passage (a passage surrounded by the main body 32 and cylindrical wall 35) located between the cylindrical housing 20 (inner space or first gas charged space 22) and the ignition device chamber 30 is blocked with a first rupturable plate 38 made from stainless steel and separated into a first passage 37a and a second passage (second gas charged space) 37b, and the inside of the ignition device chamber 30 is under a normal pressure. The circumferential edge portion of the first rupturable plate 38 is fixed by welding to the inner step portion 33a. The ignition device chamber housing 31 and cylindrical housing 20 are fixed by welding in the contact portion of the outer step portion 33b and the cylindrical housing 20.

Only the igniter 36 is disposed inside the ignition device chamber housing 31, and the igniter 36 is arranged so that the actuation portion including the ignition agent opposes the first rupturable plate 38. The igniter 36 generates a pressure wave and a shock wave when the ignition agent is actuated.

In the diffuser portion 40, an outer shell is formed by a diffuser housing 42, and a plurality of gas discharge ports 46 for discharging the pressurized gas to the outside are uniformly arranged in the diffuser housing 42.

A third passage 44 located between the cylindrical housing 20 (inner space or first gas charged space 22) and diffuser portion 40 is blocked with a second rupturable plate 48 made from stainless steel, and the inside of the diffuser portion 40 is under a normal pressure. The circumferential edge portion of the second rupturable plate 48 is welded and fixed to the diffuser housing 42.

A retainer 50 for holding the distal end portion 24a of the rod 24 is disposed in a portion in the vicinity of the diffuser portion 40 inside the cylindrical housing 20. The retainer 50 is inserted into the cylindrical housing 20, and the circumferential surface thereof and the inner wall surface. 21 of the cylindrical housing 20 are in contact, while pressing against each other.

No specific limitation is placed on the shape of the retainer 50 and it may be of any shape, provided that it can prevent the distal end portion 24a of the rod from moving in the radial direction and axial direction before the actuation. For example, the retainer can have an annular shape shown in the drawing and an orifice (acts to prevent the displacement of the distal end portion 24a of the rod in the radial direction) for inserting the distal end portion 24a of the rod into the central portion thereof.

The rod 24 has the distal end portion 24a and a disk-shaped base portion 26 located on the opposite side; all the portions are made from a metal such as stainless steel and aluminum.

The distal end portion 24a is disposed opposite the center of the second rupturable plate 48 at a distance therefrom. A short flange portion 25 is provided in the vicinity of the distal end portion 24a of the rod, and this flange portion 25 acts as a stopper for preventing the rod 24 from moving in the axial direction (in particular, toward the second rupturable plate 48) prior to the actuation.

The base portion 26 of the rod is inserted into the cylindrical wall 35, and an annular elastic material 60 is inserted between the outer peripheral surface 26a of the base portion 26 and the inner peripheral surface 35a of the cylindrical wall 35. A plurality of communication holes 27 for communicating the inner space (first gas charged space) 22 and the second passage (second gas charged space) 37b can be provided in the base portion 26 of the rod. In the embodiment shown in FIG. 2, two communication holes 27 with a diameter of 2 mm are formed. By providing such communication holes 27, the second passage (second gas charged space) 37b also can be filled with the pressurized gas.

Due to the presence of the annular elastic material 60, the pressurized gas cannot easily flow into the second passage (second gas charged space) 37b via the gap with the inner peripheral surface 35a of the cylindrical wall 35, but because the second passage (second gas charged space) 37b is also filled with the pressurized gas via the communication hole 27, the pressure is the same in all the parts of the rod 24, and the rod 24 can be propelled smoothly.

Furthermore, when the inside of the cylindrical housing is charged with the pressurized gas, the pressurized gas flows into the second passage (second gas charged space) 37b via the communication hole 27 also when the pressure resistance performance of the first rupturable plate 38 and second rupturable plate 48 is evaluated. Therefore, the pressure identical to that of the internal space (first gas charged space) 22 is applied to the first rupturable plate 38 and the pressure resistance can be evaluated accurately.

When the inner space (first gas charged space) 22 is charged with the pressurized gas in the manufacturing process, a charging hole is formed in the wall surface of the cylindrical housing 20 and the pressurized gas is charged in the predetermined amount therefrom. A seal pin is then welded to the cylindrical housing 20 to close the charging hole. The second rupturable plate 48 is bent outwardly by the pressurized gas charged into the inner space (first gas charged space) 22, and part of the charged gas reaches the second passage (second gas charged space) 37b via the communication hole 27 and causes the first rupturable plate 38 to curve outwardly.

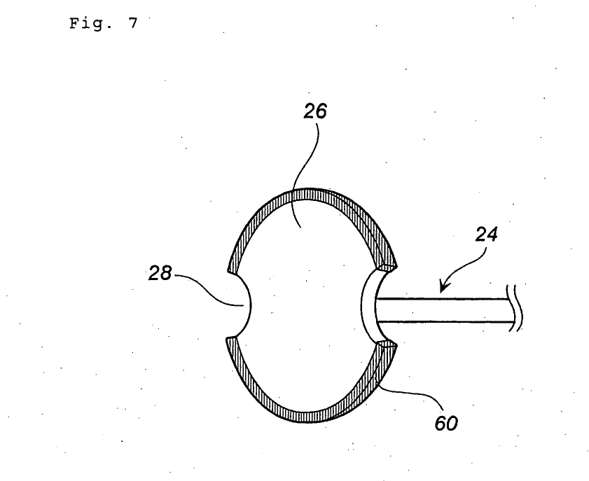

Furthermore, instead of the communication hole 27, a gap may be provided for communicating the inner space (first gas charged space) 22 with the second passage (second gas charged space) 37b in part of the passage between the cylindrical wall 35 and the annular elastic member 60, or between the annular elastic member 60 and the base portion 26 of the rod, and the second passage (second gas charged space) 37b may be charged with the pressurized gas. An example of such configuration is shown in FIG. 7.

In the rod 24 shown in FIG. 7, the base portion 26 has the shape (round) matching that of the inner peripheral surface 35a of the cylindrical wall 35, and circular-arc notches 28 are provided in two locations on the circumferential edge. An elastic member 60 is attached to the outer peripheral edge of the base portion 26, and the occurrence of noise caused by contact between the base portion and the inner peripheral surface 35a of the cylindrical wall 35 is thereby inhibited. When the rod 24 (base portion 26) is disposed inside (cylindrical wall 35) of the housing 20, a communication hole is formed by the notches 28 between the rod and the annular wall 35, whereby the inner space (first gas charged space) 22 is communicated with the second passage (second gas charged space) 37b.

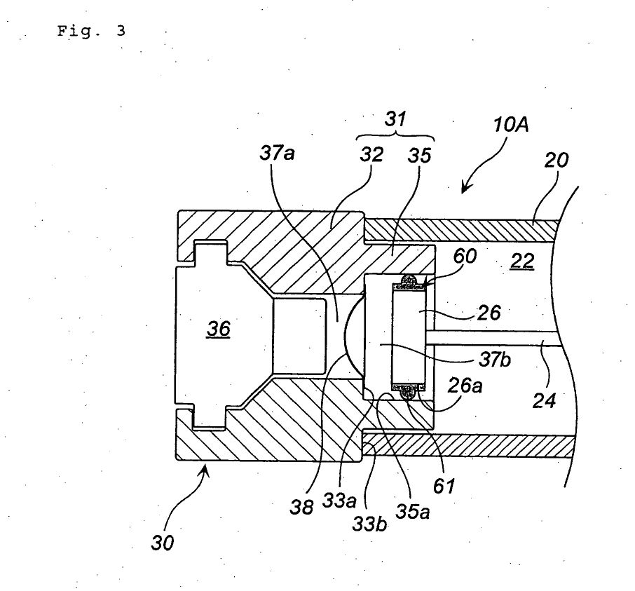

The communication hole 27 and notches 28 ensure the movement of gas from the first gas charged space 22 to the second gas charged space 37b, and the communication hole and notches are sized (have a diameter) such that, when the first blockage member 38 is broken by a shock wave or pressure wave generated within a short period by the actuation of the igniter 36, substantially the entire shock wave or pressure wave applies pressure to the base portion 26 of the rod, without passing through the communication hole 27 and notches 28. Such communication hole 27 and notches 28 can be also employed in the gas generators shown in FIGS. 3 to 6.

The annular elastic material 60 may be fixedly attached to the outer peripheral surface 26a of the base portion 26, or fixedly attached to the inner peripheral surface 35a of the cylindrical wall 35, or sandwiched between the outer peripheral surface 26a of the base portion 26 and the inner peripheral surface 35a of the cylindrical wall 35. For example, when the annular elastic body 60 is fixedly attached to the inner peripheral surface 35a of the cylindrical wall 35, the outer diameter of the base portion 26 is set to be slightly larger than the inner diameter of the annular elastic body 60. The annular elastic material 60 is made from a resin (Nylon 6, Nylon 6-12, etc.) with a thickness of about 3-5 mm.

Because the annular elastic material 60 is pressed both from the outer peripheral surface 26a of the base portion 26 and the inner peripheral surface 35a of the cylindrical wall 35, the annular elastic material is deformed to seal tightly the gap between the outer peripheral surface 26a of the base portion 26 and the inner peripheral surface 35a of the cylindrical wall 35. Furthermore, when the base portion 26 is press-inserted into the cylindrical wall 35, part of the annular elastic material 60 is shaved off, whereby the gap may be tightly sealed. Furthermore, because a force is generated which tries to restore the compressed annular elastic material 60 to the original shape thereof (shape prior to the deformation), a strong attachment is accomplished between the base portion 26 and the cylindrical wall 35.

For this reason, the unsteadiness of the rod 24 caused by external vibrations is prevented and the generation of noise is also prevented. Furthermore, by inserting the annular elastic material 60, the separation of the base portion 26 of the rod from the cylindrical wall 35 during actuation is facilitated, compared with the case where the two metal parts were mated, and the propulsion of the rod 24 can be performed smoothly.

In the embodiment shown in FIG. 1 and FIG. 2, the base portion 26 of the rod and the annular elastic material 60 are formed detachable, and first, the annular elastic material 60 is inserted to the cylindrical wall 35 (by a method including the steps of adjusting their diameters and press-inserting the annular elastic material 60 to press against the cylindrical wall 35, or a method including the steps of providing a step, having an adjusted diameter, in the inner peripheral surface of the cylindrical wall 35 and press-inserting the annular elastic material 60 to press against the cylindrical wall 35). Then, after the base portion 26 of the rod is inserted into the annular elastic material 60, the distal end portion 24a of the rod may be inserted into the retainer 50 and fixed therein, whereby the rod 24 can be pressed towards the base portion 26 from the distal end portion 24a to fix the base portion 26 of the rod.

In the embodiment shown in FIG. 1 and FIG. 2, a groove can be formed on the outer periphery of the base portion 26 of the rod, an O-ring made from an elastic material can be inserted into the groove, and the O-ring can be caused to function as the annular elastic material.

The operation of the gas generator 10 shown in FIG. 1 and FIG. 2 in the case where it was assembled with an air bag system of an automobile will be described below. In the gas generator 10, the igniter 36 from which a lead wire is led out and the gas discharge port 46 where the air bag is attached are located on the opposite sides. Therefore, the lead wire does not become an obstacle during the air bag attachment operation. Furthermore, because the annular elastic material 60 is inserted between the outer peripheral surface 26a of the base portion 26 and the inner peripheral surface 35a of the cylindrical wall 35, the noise is not generated while the automobile runs.

When an automobile collides and receives an impact, an actuation signal is received from a control unit, the igniter 36 is actuated and ignited, the first rupturable plate 38 is broken by the generated shock wave or pressure, and the first passage 37a and second passage (second gas charged space) 37b are opened. The shock wave or pressure that has broken the first rupturable plate 38 then hits and pushes the base portion 26 of the rod.

As a result, the rod 24 is propelled in the axial direction, breaks the flange portion 25, moves linearly, and collides with the second rupturable plate 48. At this time, because the cylindrical wall 35 is inclined and the annular elastic material 60 is inserted, the propulsion of the rod 24 proceeds smoothly. Under the impact of the base portion 24a of the rod, the second rupturable plate 48 is broken, the third passage 44 is opened, the pressurized gas is discharged from the gas discharge port 46, and the air bag is inflated.

(2) Gas Generator Shown in FIG. 3

FIG. 3 is a partially enlarged cross-sectional view of the gas generator 10A for an air bag of an embodiment different from that illustrated by FIG. 1 and FIG. 2. The components denoted by the reference numbers identical to those in FIG. 1 and FIG. 2 are the same. Only the components different from those shown in FIG. 1 and FIG. 2 will be explained.

The cylindrical wall 35 is not inclined and has a uniform inner diameter. The annular elastic material 60 is attached to the outer peripheral surface 26a of the base portion 26 of the rod. The annular elastic material 60 has a plurality of protrusions 61 protruding in the radial direction. There are four or more protrusions 61 provided with equal intervals on the outer peripheral surface of the annular elastic body 60.

Before the base portion 26 of the rod is pushed into the cylindrical wall 35, the outer diameter of the base portion 26 of the rod, including the protrusions 61 of the annular elastic material 60, is set slightly larger than the inner diameter of the cylindrical wall 35.

When the base portion 26 of the rod is pushed into the cylindrical wall 35, the protrusions 61 of the annular elastic material 60 are deformed to be collapsed or shaved off, thereby providing for the action identical to that of the gas generator shown in FIG. 1.

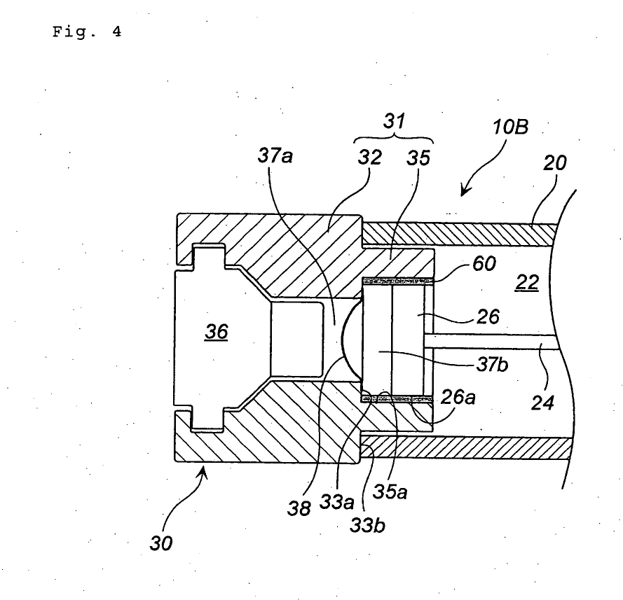

(3) Gas Generator Shown in FIG. 4

FIG. 4 is a partially enlarged cross-sectional view of the gas generator 10B for an air bag of an embodiment different from that illustrated by FIG. 1 and FIG. 2. The components denoted by the reference numbers identical to those in FIG. 1 and FIG. 2 are the same only the components different from those shown in FIG. 1 and FIG. 2 will be explained.

The cylindrical wall 35 is not inclined and has a uniform inner diameter. The annular elastic material 60 is attached to the inner peripheral surface 35a. Before the base portion 26 of the rod is pushed into the cylindrical wall 35, the outer diameter of the base portion 26 of the rod is set slightly larger than the inner diameter of the annular elastic material 60 attached to the cylindrical wall 35.

When the base portion 26 of the rod is pushed into the annular elastic material 60 of the cylindrical wall 35, the annular elastic material 60 is deformed to be pushed outwardly and expanded, thereby providing for the action identical to that of the gas generator shown in FIG. 1. In the configuration shown in FIG. 4, the base portion 26 may be tapered to facilitate the insertion of the base portion 26 of the rod into the annular elastic material 60.

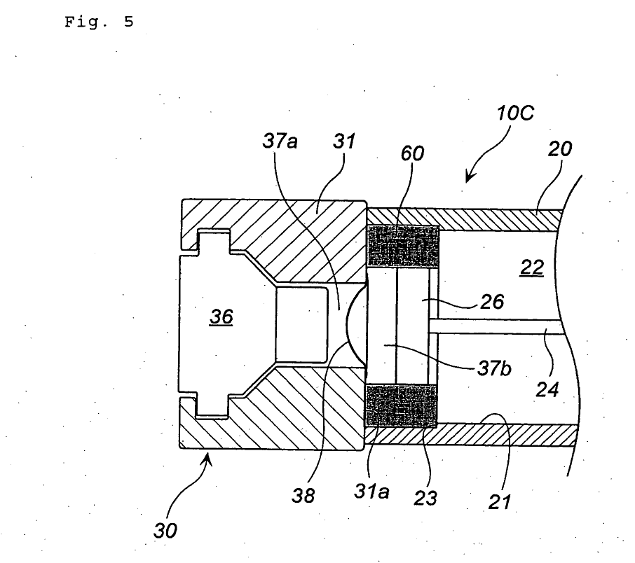

(4) Gas Generator Shown in FIG. 5

FIG. 5 is a partially enlarged cross-sectional view of the gas generator 10C for an air bag of an embodiment different from that illustrated by FIG. 1 and FIG. 2. The components denoted by the reference numbers identical to those in FIG. 1 and FIG. 2 are the same. Only the components different from those shown in FIG. 1 and FIG. 2 will be explained.

The ignition device chamber housing 31 does not have the cylindrical wall 35 such as that of the gas generator shown in FIGS. 1 to 4. An annular step surface 23 is provided on the inner wall surface 21 of the cylindrical housing 20 in the vicinity of the ignition device chamber housing 31, and the annular elastic material 60 is inserted between the annular step surface 23 and the end surface 31a of the ignition device chamber housing.

Before the base portion 26 of the rod is pushed into the annular elastic material 60, the outer diameter of the base portion 26 of the rod is set slightly larger than the inner diameter of the annular elastic material 60.

When the base portion 26 of the rod is pushed into the annular elastic material 60, the annular elastic material 60 is deformed to be pushed outwardly and expanded, thereby providing for the action identical to that of the gas generator shown in FIG. 1. In the configuration shown in FIG. 5, the base portion 26 may be tapered to facilitate the insertion of the base portion 26 of the rod into the annular elastic material 60.

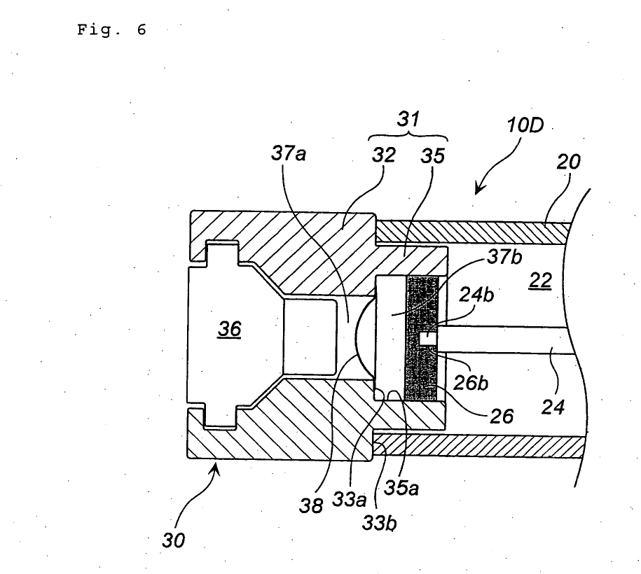

(5) Gas Generator Shown in FIG. 6

FIG. 6 is a partially enlarged cross-sectional view of the gas generator 10D for an air bag of an embodiment different from that illustrated by FIG. 1 and FIG. 2. The components denoted by the reference numbers identical to those in FIG. 1 and FIG. 2 are the same. Only the components different from those shown in FIG. 1 and FIG. 2 will be explained.

The disk-shaped base portion 26 of the rod is made from an elastic material (Nylon 6, Nylon 6-12, or the like), and the base portion 26 itself acts in the same manner as the elastic material 60 of FIG. 1 and FIG. 2. A hole 26b is provided in the central portion of the base portion 26, and the rod 24 and the base portion 26 are joined and fixed by inserting a convex portion 24b provided at the end surface of the rod 24 into the hole 26b.

Before the base portion 26 of the rod is pushed into the cylindrical wall 35, the outer diameter of the base portion 26 of the rod is set slightly larger than the inner diameter of the cylindrical wall 35.

When the base portion 26 of the rod is pushed into the cylindrical wall 35, the base portion 26 itself is deformed to be compressed inwardly, thereby providing for the action identical to that of the gas generator shown in FIG. 1.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator for a restraining device in an automobile, comprising:
a cylindrical housing having two opening portions;
an ignition device chamber connected to one of the opening portions of the cylindrical housing;
a diffuser portion connected to the other opening portion of the cylindrical housing and having a gas discharge port;
a first blockage member closing between the cylindrical housing and the ignition device chamber;
a second blockage member closing between the cylindrical housing and the diffuser portion;
a pressurized gas charged inside the cylindrical housing;
a metal rod, for rupturing the second blockage member to open a path to the diffuser portion in actuation, being provided in the cylindrical housing, the metal rod being disposed, including a base portion thereof in contact with a metallic wall surface in the vicinity of the first blockage member,
an elastic material being inserted into a contacting portion which is pressed from both of the base portion and the metallic wall surface in the vicinity of the first blockage member.

2. The gas generator for a restraining device for a vehicle according to claim 1, wherein an outer shell of the ignition device chamber is formed by an ignition device chamber housing, the ignition device chamber housing has a cylindrical wall formed to protrude inside the cylindrical housing, and the cylindrical wall and the base portion of the rod are in contact with each other.

3. The gas generator for a restraining device for a vehicle according to claim 2, wherein the cylindrical wall is inclined as to expand toward the second blockage member.

4. The gas generator for a restraining device for a vehicle according to claim 2, wherein at least one of an inner surface of the cylindrical wall and an outer surface of the base portion of the rod has an elastic material.

5. The gas generator for a restraining device for a vehicle according to claim 4, wherein a protrusion is provided in a surface of the elastic material of the base portion of the rod.

6. The gas generator for a restraining device for a vehicle according to claim 1, wherein the cylindrical housing and the base portion of the rod are in contact with each other, and at least one of an inner surface of the cylindrical housing and an outer surface of the base portion of the rod has an elastic material.

7. The gas generator for a restraining device for a vehicle according to claim 1, wherein the base portion of the rod is formed from an elastic material.

8. The gas generator for a restraining device for a vehicle according to claim 1, wherein the elastic material is a rubber, a resin, or an elastomer.

9. A gas generator for a restraining device for a vehicle, comprising:
a cylindrical housing having two opening portions;
an ignition device chamber connected to one of the opening portions of the cylindrical housing;
a diffuser portion connected to the other opening portion of the cylindrical housing and having a gas discharge port,
a first blockage member closing between the cylindrical housing and the ignition device chamber;
a second blockage member closing between the cylindrical housing and the diffuser portion;
a pressurized gas charged in a first gas charged space inside the cylindrical housing,
a metal rod, for rupturing the second the blockage member and opening a path to the diffuser portion in actuation, being disposed inside the cylindrical housing, the metal rod being disposed, including a base portion thereof in contact of a metallic wall surface in the vicinity of the first blockage member;
a second gas charged space existing between the first blockage member and the base portion of the rod; and
a communication hole being provided in the base portion of the rod and communicating the first gas charged space with the second gas charged space.

10. The gas generator for a restraining device for a vehicle according to claim 9, wherein the base portion of the rod is a member in the form of a substantially flat plate, and the communication hole is a through hole formed in the member in the form of a substantially flat plate.

11. The gas generator for a restraining device for a vehicle according to claim 9, wherein the base portion of the rod is a member in the form of a substantially flat plate, and the communication hole is a gap formed between the member in the form of a substantially flat plate and the metallic wall surface.

12. The gas generator for a restraining device for a vehicle according to claim 9, wherein in a contact portion of the base portion and the metallic wall surface, an elastic material is inserted to be pressed from both the base portion and the metallic wall surface.

13. The gas generator for a restraining device for a vehicle according to claim 10, wherein in a contact portion of the base portion and the metallic wall surface, an elastic material is inserted to be pressed from both the base portion and the metallic wall surface.
